(19) United States
(12) Patent Application Publication
(10) Pub. No.: US 2007/0097872 A1
(43) Pub. Date: May 3, 2007

(54) Network connection apparatus testing method

(75) Inventor: Shih-Hua Chiu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/261,815

(22) Filed: Oct. 27, 2005

(51) Int. Cl. H04L 12/26

(52) U.S. Cl. 370/250

(57) ABSTRACT

A network connection apparatus testing method is proposed. The method first provides a first terminal apparatus having at least an inlaid test program and a test parameter, and a second terminal apparatus having a packet capturing program and an execution parameter, then enables the first terminal apparatus to transmit a group of testing data packets to the second terminal apparatus, and counts a number of the test data packets that have been transmitted until the number is equal to a setting value of the test parameter. The method then counts a number of the test data packets received by the second terminal apparatus, compares the test parameter with the number of the received test data packets, and calculates a receiving rate of the test data packet. The method therefore judges the efficiency of the connecting port assembled in a network connection apparatus according to the receiving rate.

### BACKGROUND OF THE INVENTION

1. Field of the Invention

The present invention relates generally to test technology of connection apparatus and, more particularly, to a network connection apparatus testing method used for detecting the efficiency of a connecting port assembled in a network connection apparatus to receive data packets.

2. Description of Related Art

With the explosive development of computer technology and Internet, scale of the information platform built on the computer internet in enterprise is becoming more and more large, from a tiny network connected to only one computer to a huge network connected to Internet and hundreds of computers, acquiring Internet information having become an important function for computer. Simultaneously, various network connection apparatus acted as necessary device have played important part in connecting multiple computers to internet, wherein, it is most common to apply in the process for building network in enterprise by employing various switches and hubs.

However, as to network connection apparatus, different network connection apparatuses are possible to cause fault during using due to the flaws produced in manufacture or assembly, affecting transport performance of signal, thereby making the terminal connected to the connecting port, e.g., personal computer and the like, can not receive or transmit data with full accuracy rate, once hardware trouble of the connecting port is occurred, the whole network may not run properly, therefore, whether network connection apparatus is good or bad is an important condition for determining the network connecting quality is good or bad, and is key of that whether can provide network connection apparatus with high efficiency to promote the reliability of network connection.

At present, most enterprises often employ certain testing instrument to perform correlative pressure test for testing the reliability of network connection, but such kind of instrument is quite expensive, and it is not easy for general technical staff to understand and grasp how to manipulate, set, administer and maintain such kind of instrument. Most important, as far as the realizing scheme of the present technique is concerned, it is may not be quite complex to test efficiency of various connecting ports in the network connection apparatus, but it is worthless for the enterprise to take huge sum to finish such test. In addition, there exists a problem of lacking uniform public credibility due to different test software for different products adhered by various manufacturers of network connection apparatus.

Accordingly, there exists a strong need in the art for a network connection apparatus testing method to solve drawbacks of the test technology, so as to make enterprise quickly and efficiently detect efficiency of the network connection apparatus and prevent from expensive cost of test instrument.

### SUMMARY OF THE INVENTION

Accordingly, it is an objective of the present invention to solve the drawbacks of the aforementioned conventional technology by providing a network connection apparatus testing method, which can quickly and efficiently detect a data receiving efficiency of various connecting ports assembled in the network connection apparatus.

It is another objective of the present invention to provide a network connection apparatus testing method to make enterprise test transmitting and receiving state of the network connection apparatus without huge sum for purchasing expensive test instrument and additional software and hardware.

It is a further objective of the present invention to provide a network connection apparatus testing method having an expandable testing structure to authentically test the performance of the connecting ports assembled in the network connection apparatus.

In order to attain the object mentioned above, a network connection apparatus testing method is provided according to the present invention. The method is used to test the efficiency of various connecting ports of the network connection apparatus to receive data packets. The method includes providing at least a first terminal apparatus and a second terminal apparatus, both of which are respectively connected to a first connecting port and a second connecting port assembled in the network connection apparatus, the first terminal apparatus having a test program and a test parameter set by the test program and being capable of transmitting a data packet according to a setting value of the test parameter, the second terminal apparatus having a packet capturing program and an execution parameter set by the execution program and being capable of acquiring a data packet according to a setting value of the executive parameter; enabling the first terminal apparatus when executing the test program to transmit a group of test data packets to the second terminal apparatus, and counting a number of the test data packets that have been transmitted by the first terminal apparatus until the number is equal to the setting value of the test parameter; enabling the second terminal apparatus to execute the packet capturing program to acquire the test data packets transmitted from the first terminal apparatus, and counting a number of the test data packets received by the second terminal apparatus; comparing the test parameter set by the test program with the number of the received test data packets counted by the packet capturing program, and calculating a receiving rate of the test data packets; and judging an efficiency of the connecting port assembled in the network connection apparatus according to the receiving rate.

Compared with the test technology of efficiency of the conventional network connection apparatus, network connection apparatus testing method according to the present invention employs terminal to programming control data packet, and acquires the test result of efficiency of various connecting ports assembled in the connection apparatus according to the transmitting and receiving state of test dada packet, making the enterprise quickly and efficiently detect the efficiency of network connection apparatus without taking high cost to purchase additional software and hardware device, and test where the problem of the network apparatus is and the packet losing rate of each connecting port within a certain time.

### BRIEF DESCRIPTION OF DRAWINGS

FIG. 1 depicts an operating flow chart of the exemplary steps for executing a network connection apparatus testing method according to the present invention.

FIG. 2 depicts a connecting schematic diagram of testing a data receiving efficiency of a first connecting port and a second connecting port assembled in a network connection apparatus according to the present invention.

FIG. 3 depicts a system connecting schematic diagram of testing efficiency of multiple connecting ports of a hub.

FIG. 4 depicts a system connecting schematic diagram of testing efficiency of multiple connecting ports of a switch.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

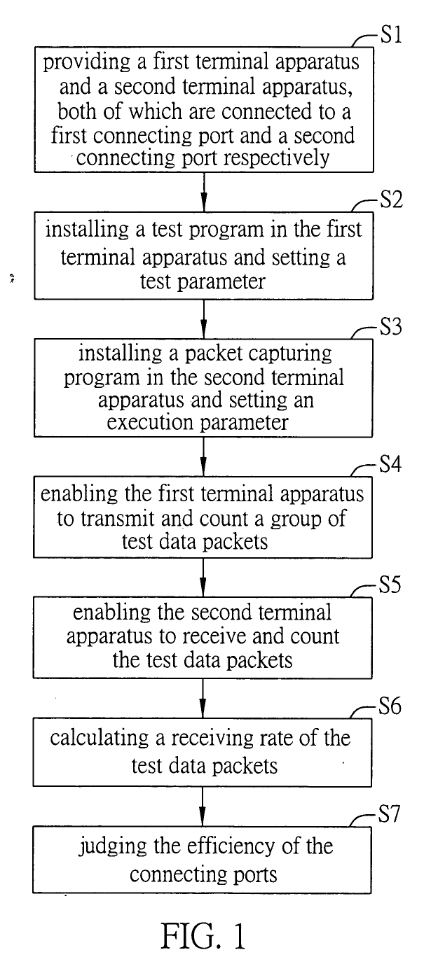

With reference to FIG. 1, shown is an operating flow chart of the exemplary steps for executing a network connection apparatus testing method according to the present invention. The network connection apparatus testing method according to the present invention is used to test the data transmitting/receiving rate of a connecting ports assembled in a network connection apparatus. The network connection apparatus at least comprises a first connecting port, a second connecting port, a network card for transmitting and receiving data packets. The network connection apparatus is designed to run any kinds of operating system (OS), such as Windows or Linux OS. Note that in the exemplary embodiment a terminal apparatus can be a personal computer, a notebook computer or a workstation. The network connection apparatus can be a switch, a hub or a switched hub of various types produced by any manufacturer.

With reference to FIG. 1, the method begins in step S1 to provide at least a first terminal apparatus and a second terminal apparatus, both of which are respectively connected to the first connecting port and the second connecting port of the network connection apparatus that is to be detected. Then proceed to step S2.

In step S2, the first terminal apparatus is embedded with a test program, and a test parameter is set by the test program accordingly, enabling the first terminal apparatus to transmit a data packet according to a setting value of the test parameter. In the exemplary embodiment, the test program is a packet Internet groper, i.e., a conventional Ping instrument, and the test parameter at least comprises one selected from a group consisting of a number of test data packet needed to be transmit, a size of the test data packet, and a receiving rate of the test data packets in a single test. For example, the size of the test data packets can be set to a size that Windows supports, the first terminal apparatus is designed to transmit N (=1000) test data packets, each of which has 1280 bytes, in a single test, and the network connection apparatus is judged to be a qualified product if a receiving rate of the test data packets received by the second terminal apparatus is larger than 90%. Note that the size of the testing data packet is defined according to a standard constituted by Internet Engineering Task Force (IETF), and can have a size of 64, 128, 256, 1024, 1280 or 1518. Whether a test result is successful or not is defined according to the standard constituted by Internet Engineering Task Force (IETF). Then proceed to step S3.

In step S3, a packet capturing program and an execution parameter are embedded in the second terminal apparatus, enabling the second terminal apparatus to acquire the test data packet according to a setting value of the executive parameter. In the exemplary embodiment, the packet capturing program is an ethereal packet acquiring software. In an actual application process, an internet protocol type in the software is set to be Internet control Message Protocol (ICMP), and a type value of ICMP rule is set to be 8. Under the ICMP rule, the second terminal apparatus automatically provides a reply to indicate that the test data packets are received provided after receiving the test data packets. After such a setting process is completed, the second terminal apparatus runs the packet acquiring software to receive the test data packets. Next proceed to step S4.

In step S4, when executing the test program the first terminal apparatus transmits a group of test data packets to the second terminal apparatus, and counts a number of the data packets that have been transmitted until the number of the transmitted test data packets is equal to the setting value of the test parameter, which is set by the test program previously. In the exemplary embodiment, the first terminal apparatus is designed to execute the Ping instruction and transmit N (=1000) test data packets, each of which has 1280 bytes, in a single test to a specified address, and count a number M of test data packets that have been transmitted in the single test. The number M is added by one every time when one test data packet is transmitted by the first terminal apparatus until the number M is equal to the number N, that is 1000. Then proceed to step S5. In step S5, the second terminal apparatus executes the packet capturing program to acquire the test data packets transmitted from the first terminal apparatus, and counts a number P of the test data packets that have been received by the second terminal apparatus. In the exemplary embodiment, after receiving the test data packets the second terminal apparatus returns information representing that the test data packets have been received by the second terminal apparatus, and counts the number P. The number P is added by one every time when the second terminal apparatus receives one test data packet until the number P is equal to N, that is 1000, which means that test is completed. Then proceed to step S6. In step S6, the test parameter set by the test program is compared with the number P of the test data packets that have been received by the second terminal apparatus and counted by the packet capturing program, and a receiving rate of the test data packets is calculated. In the exemplary embodiment, the second terminal apparatus is assumed to have received 950 test data packets, i.e., P=950, which means that the receiving rate of the test data packet is 95% (P/M). Then proceed to step S7.

In step S7, the data receiving efficiency of the first connecting port and the second connecting port assembled in the network connection apparatus that has been tested is judged according to the receiving rate of the test data packets. In the exemplary embodiment, the receiving rate is 95%, which is larger than a predetermined receiving rate of 90%, so the data receiving efficiency of the connecting ports assembled in the network connection apparatus is quite excellent. In addition, such a test result can be recorded in the terminal apparatuss for future reference.

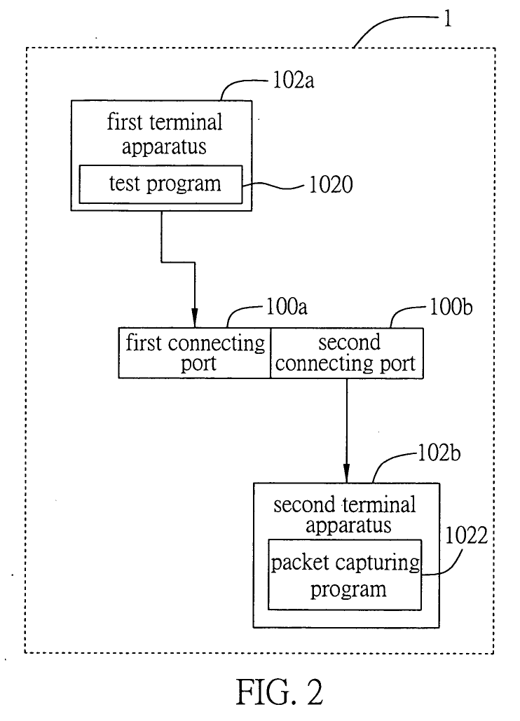

With reference to FIG. 2, shown is a connecting schematic diagram of testing the data receiving efficiency of a first connecting port 100a and a second connecting port 100b assembled in a network connection apparatus 100 according to the present invention. As shown in FIG. 1, a network connection apparatus testing system 1 is installed to test the network connection apparatus 100, which at least comprises the first connecting port 100a and the second connecting port 100b. A first terminal apparatus 102a is connected to the first connecting port 100a, and a second terminal apparatus 102b is connected to the second connecting port 100b. A test program 1020 and a corresponding test parameter are installed in the first terminal apparatus 102a, and a packet capturing program 1022 and a corresponding executive parameter are installed in the second terminal apparatus 102b. The test program 1020 is executed to transmit a group of test data packets to the second terminal apparatus 102b, and to count a number of the test data packets that have been transmitted by the first terminal apparatus 102a until the number is equal to a setting value of the test parameter. The packet capturing program 1022 is then executed to acquire the test data packets transmitted from the first terminal apparatus 102a, and to count a number of the test data packets that have been received by the second terminal apparatus 102b, so as to calculate a packet receiving rate and judge the data receiving efficiency of the first connecting port 100a and the second connecting port 100b.

In addition, if it is required to test efficiency of other connecting port assembled in the network connection apparatus 100, it must make each connecting port that is to be detected correspondingly connect to a terminal, then repeat the step 1 to step 6 of the above-discussed method, thereby the test result of efficiency of each connecting port that is to be detected can be acquired. The following is to respectively employ hub and switch with 16 connecting ports to further describe the implementary situation if it is required to test each connecting port that is to be detected.

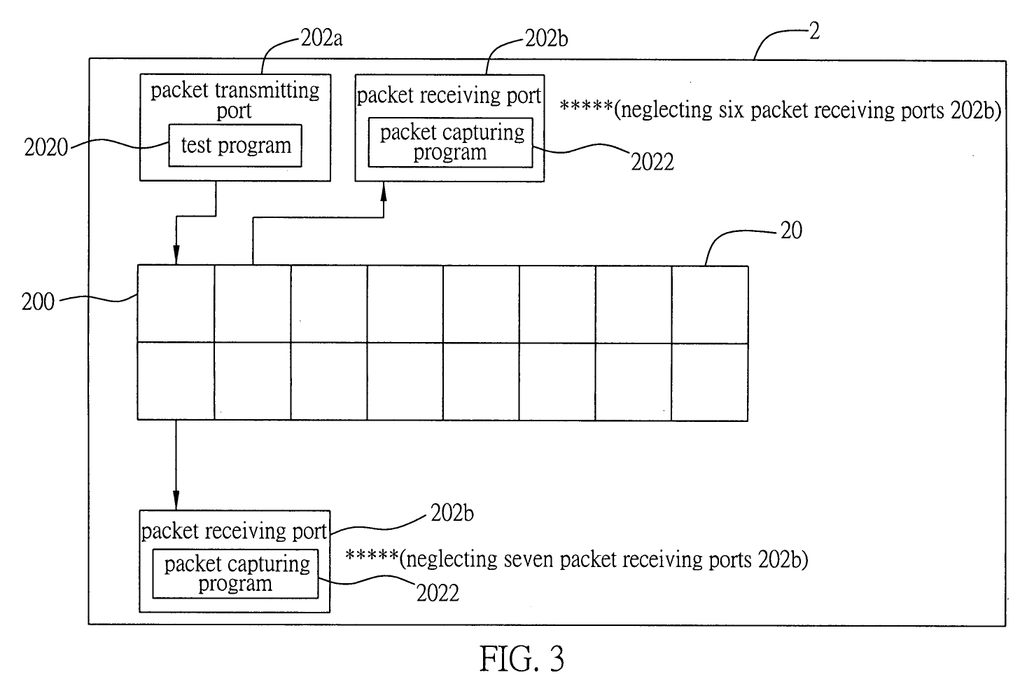

Please refer to FIG. 3, which is a connecting schematic diagram of testing efficiency of multiple connecting ports assembled in hub. Generally, data packet in hub is transmitted by axle ways, i.e., when the terminal correspondingly connected to any connecting port that is to be detected sends data packet, the terminal correspondingly connected to other connecting port that is to be detected and waiting for receiving data packet can receive the data packet, therefore, if it is needed test result of efficiency of all connecting ports, it can do nothing but connect a terminal for intercepting test packet to the corresponding connecting port, and open the packet capturing program to wait for receiving data packet.

As shown in FIG. 3, if the efficiency of 16 connecting ports assembled in a hub 20 is required to be test, each connecting port 200 that is to be detected should be correspondingly connected to a terminal. The terminal comprises a packet transmitting port 202a and a packet receiving port 202b. The packet transmitting port 202a comprises a test program 2020 to control the packet transmitting port 202a to transmit test data packets, and the packet receiving port 202b comprises a packet capturing program 2022 to control the packet receiving port 202b to capture the test data packets. The efficiency of the connecting port 200 can be obtained by executing steps S4-S7 shown in FIG. 1 at the terminal.

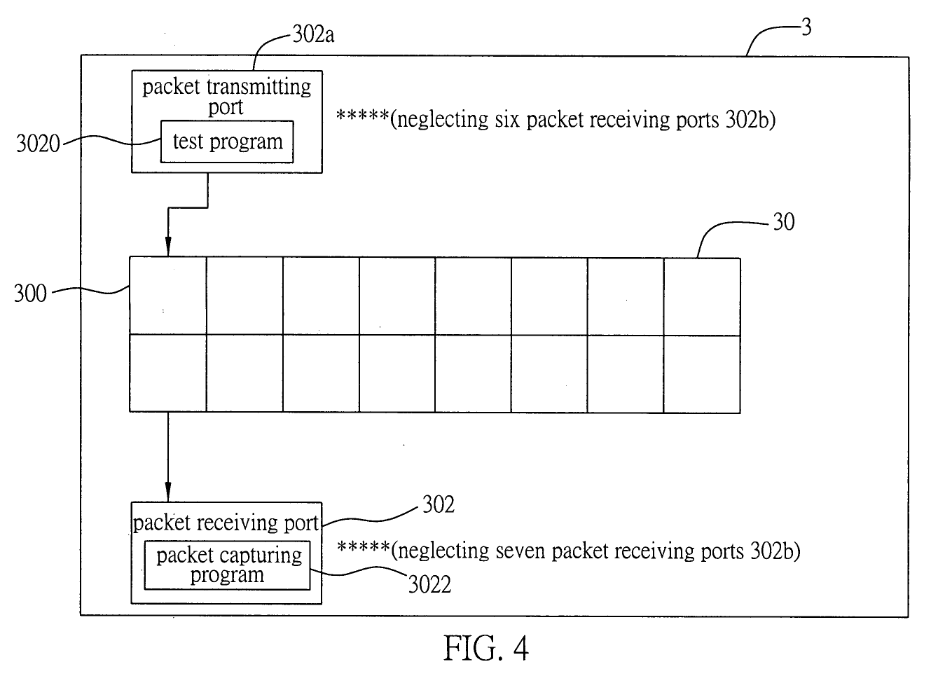

Please refer to FIG. 4, which is a system connecting schematic diagram of testing efficiency of multiple connecting ports of switch. Data packet in switch is transmitted by actual address ways, i.e., when the terminal merely transmits data packet to a connecting port with specified address, only the terminal connected to the connecting port can receive the data packet, if it is needed test result of efficiency of all connecting ports, the terminal for transmitting packets and terminal for intercepting test packet should be connected to each connecting port, and sending destination address must be established when transmitting packet.

As shown in FIG. 4, if efficiency of 16 connecting ports assembled in a switch 30 is required to be test, the terminal connected to a connecting port 300 is divided into two kinds, one being a packet transmitting port 302a and the other being a packet transmitting port 302b. The 16 connecting ports 300 assembled in the switch efficiency test system 3 are respectively connected to eight terminals. In other words, the connecting ports 300 are connected to eight packet transmitting ports 302a and eight packet transmitting ports 302b respectively, and the eight packet transmitting ports 302a and the eight packet transmitting ports 302b are built according to a specified relation. The packet transmitting port 302a comprises a test program 3020 to control the packet transmitting port 302a to transmit test data packets, and the packet receiving port 302b comprises a packet capturing program 3022 to control the packet receiving port 302b to capture the test data packets. The efficiency of the corresponding connecting port 300 can be obtained at the terminal by executing steps S4-S7 shown in FIG. 1. Note that is step S4 the packet transmitting port 302a is used to transmit the test data packets to the packet receiving port 302b for establishing address.

The above-described exemplary embodiments are to describe various objects and features of the present invention as illustrative and not restrictive. A person of ordinary skill in the art would recognize that changes could be made in form and detail without departing from the sprit and the scope of the invention. Thus, the right protective scope of the present invention should fall within the appended claim.

What is claimed is:

1. A network connection apparatus testing method used to test an efficiency of a connecting port assembled in a network connection apparatus to receive data packets, the method comprising:
providing at least a first terminal apparatus and a second terminal apparatus, both of which are respectively connected to a first connecting port and a second connecting port assembled in the network connection apparatus, the first terminal apparatus having a test program and a test parameter set by the test program and being capable of transmitting a data packet according to a setting value of the test parameter, the second terminal apparatus having a packet capturing program and an execution parameter set by the execution program and being capable of acquiring a data packet according to a setting value of the executive parameter;
enabling the first terminal apparatus when executing the test program to transmit a group of test data packets to the second terminal apparatus, and counting a number of the test data packets that have been transmitted by the first terminal apparatus until the number is equal to the setting value of the test parameter;
enabling the second terminal apparatus to execute the packet capturing program to acquire the test data packets transmitted from the first terminal apparatus, and counting a number of the test data packets received by the second terminal apparatus;
comparing the test parameter set by the test program with the number of the received test data packets counted by the packet capturing program, and calculating a receiving rate of the test data packets; and
judging an efficiency of the connecting port assembled in the network connection apparatus according to the receiving rate.

2. The network connection apparatus testing method of claim 1, wherein the first terminal comprises a network card, which is used for the first terminal to transmit and receive a data packet over a network.

3. The network connection apparatus testing method of claim 1, wherein the first terminal is one selected from a group consisting of a personal computer, a notebook computer and a workstation.

4. The network connection apparatus testing method of claim 1, wherein the network connection apparatus is one selected from a group consisting of a switch and a hub.

5. The network connection apparatus testing method of claim 1, wherein the test program is packet Internet groper (Ping).

6. The network connection apparatus testing method of claim 1, wherein the packet capturing program is an ethereal packet capturing program.

7. The network connection apparatus testing method of claim 1, wherein the test parameter set by the test program at least comprises one selected from a group consisting of a number of test data packet needed to be transmit, a size of the test data packet, and a receiving rate of the test data packets in a single test.

8. The network connection apparatus testing method of claim 7, wherein the size of the test data packet is defined according to a standard constituted by Internet Engineering Task Force (IETF).

9. The network connection apparatus testing method of claim 1, wherein the executive parameter set by the execution program at least comprises an Internet protocol type.

10. The network connection apparatus testing method of claim 9, wherein the Internet protocol type is Internet control Message Protocol (ICMP).
